(19) United States
(12) Patent Application Publication
(10) Pub. No.: US 2020/0316411 A1
(43) Pub. Date: Oct. 8, 2020

(54) PROCESS FOR MANUFACTURING FIREFIGHTER PROTECTIVE GARMENTS AND FIREFIGHTER PROTECTIVE GARMENTS PRODUCED THEREFROM

(71) Applicant: INNOTEX INC, Richmond (CA)

(72) Inventors: Claude BARBEAU, Richmond (CA); Danny ROY, Richmond (CA)

(21) Appl. No.: 16/841,237

(22) Filed: Apr. 6, 2020

Related U.S. Application Data
(60) Provisional application No. 62/830,011, filed on Apr. 5, 2019.

(51) Int. Cl. A62B 17/00; A41D 13/01

(52) U.S. Cl. CPC A62B 17/003; A41D 31/325; A41D 13/01

(57) ABSTRACT

There is provided a process for manufacturing a firefighter protective garment. The process includes providing an outer shell material having an exposed surface; printing one or more reflective features directly on the exposed surface of the outer shell material; cutting the outer shell material to define outer shell panels; and assembling the outer shell panels to form an outer shell of the firefighter protective garment with the reflective features facing outwardly of said garment. There is also provided a firefighter protective garment, including an inner liner and an outer shell made from a flame-resistant material, the outer shell extending over at least a portion of the inner liner. The outer shell has an outermost surface, the outermost surface including reflective features printed directly thereon, the reflective features facing outwardly of said firefighter protective garment. The garment may be a firefighter protective coat and/or firefighter protective pants.

### TECHNICAL FIELD

The technical field generally relates to a process for manufacturing firefighter protective garments and firefighter protective garments produced therefrom, and more particularly concerns a process for manufacturing firefighter protective garments having printed reflective features, as well the firefighter protective garments produced therefrom.

### BACKGROUND

The firefighter protective garments of prior art generally include bands on an outermost layer of the outer shell, so that the firefighters remain visible during their firefighting activities. Such bands are generally provided under the form of tape or material band, that can be affixed, i.e., glued and/or seamed on an exterior surface of the outer shell. Referring to FIG. 1 (PRIOR ART), there is illustrated an example of a firefighter protective garment according to prior art.

When it comes to manufacturing such garments, materials are generally provided on a roll and unwrapped. The unwrapped material is then cut (“cutting step”) and marked at locations (“marking step”) where the bands are to be affixed. The bands are subsequently provided and affixed (“affixing step”) to the firefighter garment at the marked locations. It is to be noted that the step of affixing, which generally includes seaming or gluing the bands, is typically manually performed by a seamster or seamstress. This is associated with numerous challenges, such as the efficiency of the whole manufacturing process and the fluctuations in the availability of the workforce for performing such repetitive tasks.

There is a need in the industry for firefighter garments and related methods that alleviate at least in part the deficiencies of conventional firefighter garments and methods and seeks to solve problems and drawbacks of the prior art.

### SUMMARY

Process for manufacturing firefighter protective garments, and more particularly for manufacturing firefighter protective garments including printed reflective features, as well as firefighter protective garments produced therefrom are described herein.

In accordance with one aspect, there is provided a process for manufacturing a firefighter protective garment, the process including:
providing an outer shell material having an exposed surface;
printing one or more reflective features directly on the exposed surface of the outer shell material;
cutting the outer shell material to define outer shell panels; and
assembling the outer shell panels to form an outer shell of the firefighter protective garment with the reflective features facing outwardly of said garment.

In some embodiments, providing the outer shell material includes unrolling an unprinted material web from a web roller and conveying the unprinted material web.

In some embodiments, printing said one or more reflective features includes applying a solution containing a reflective material on the exposed surface of the outer shell material.

In some embodiments, applying said solution is carried out using inkjet printing.

In some embodiments, applying said solution is carried out using screen printing.

In some embodiments, applying said solution is carried out using transfer printing.

In some embodiments, applying said solution is carried out using thermal transfer printing.

In some embodiments, applying said solution includes mechanically contacting the outer shell material with a sponge filled with said solution.

In some embodiments, applying said solution includes mechanically contacting the outer shell material with a roller covered with said solution.

In some embodiments, applying said solution includes dispensing said solution from a printing head.

In some embodiments, the process further includes:
monitoring a position of the printing head relative to the outer shell material with a sensor;
generating a displacement command with a controller, based on the monitored position of the printing head; and
displacing the printing head towards a subsequent position, based on the displacement command.

In some embodiments, the process further includes thermally treating said solution after the application of said solution on the exposed surface of the outer shell.

In some embodiments, the process further includes optically treating said solution after the application of said solution on the exposed surface of the outer shell.

In some embodiments, the process further includes, prior to the application of said solution, providing an absorbent layer underneath the outer shell material configured to absorb an excess of said solution.

In some embodiments, printing said one or more reflective features includes projecting a particulate substance containing a reflective material on the exposed surface of the outer shell material.

In some embodiments, the particulate substance includes a magnetic substance, the process further including magnetically charging the outer shell material.

In some embodiments, the process further includes thermally treating said particulate substance after the projection of said particulate substance on the exposed surface of the outer shell.

In some embodiments, the process further includes optically treating said particulate substance after the projection of said particulate substance on the exposed surface of the outer shell.

In some embodiments, optically treating the particulate substance includes exposing the particulate substance to ultraviolet radiation.

In some embodiments, the process further includes providing position marks on the outer shell material for said one or more reflective features prior to said printing.

In some embodiments, providing the position marks includes printing the position marks.

In some embodiments, the process further includes detecting at least one of the position marks with a camera and beginning printing said one or more reflective features following detection of said at least one of the position marks.

In some embodiments, the process further includes tracing at least one pattern defining at least one zone to be covered with the reflective material, before printing said one or more reflective features.

In some embodiments, the process further includes heating the outer shell material.

In some embodiments, assembling the outer shell panels includes securing together at least two outer shell panels.

In accordance with another aspect, there is provided a firefighter protective garment, including:
an inner liner; and
an outer shell made a flame-resistant material, the outer shell extending over at least a portion of the inner liner, the outer shell having an outermost surface, the outermost surface including reflective features printed directly thereon, the reflective features facing outwardly of said firefighter protective garment.

In accordance with another aspect, there is provided a firefighter protective garment having an outer shell including printed reflective features. The printed features are made from a printable material provided on the outermost layer of the outer shell and are visible from the outside of the firefighter protective garment when worn by the firefighter. Methods for manufacturing such a garment is also provided. The methods include a step of printing a printable material to obtain the printed reflective features.

In some embodiments, the method includes a step of printing one or more reflective features.

In some embodiments, the reflective material is provided at least some of the waist portion(s), the leg portion(s), the ankle portion(s), the arm portion(s) and the wrist portion(s) of the firefighter protective garment.

In some embodiments, the printed features include other customization features.

In some embodiments, the step of printing the printed feature(s) includes a step of screen printing to transfer the printable material onto the outer shell, except in predetermined areas. In some embodiments, this step includes blocking regions of the outer shell material with a stencil. The stencil may include full portions, as well as opened portions for allowing the passage of the printable material therethrough.

In some embodiments, the printable material is poured, a movable blade or squeeze sweeps the surface of the stencil to fill the opened portions of the stencil, and the stencil is momentarily applied to, i.e., pressed against the outer shell material, thereby transferring the printable material to the outer shell.

Other features and advantages of the present description will become more apparent upon reading of the following non-restrictive description of specific embodiments thereof, given by way of example only with reference to the accompanying drawings.

### BRIEF DESCRIPTION OF THE DRAWINGS

FIG. 1 illustrates a firefighter protective garment of prior art.

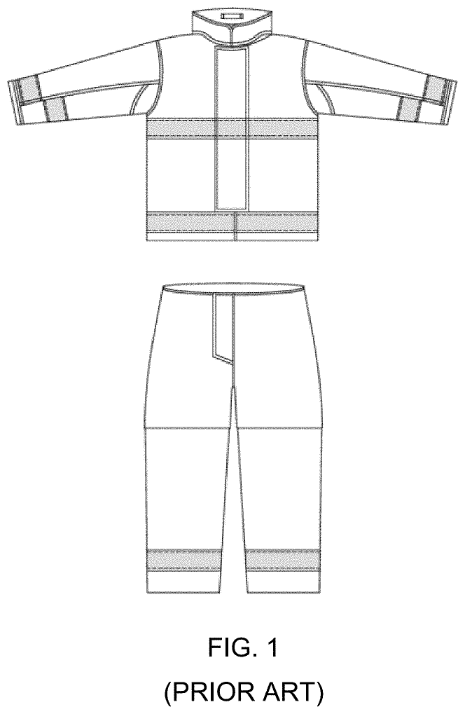

FIG. 2 is a flowchart illustrating a process for manufacturing a firefighter protective garment, in accordance with one embodiment.

FIGS. 3A-B show a printing station for sequentially printing reflective features with different printing techniques, in accordance with one embodiment.

FIGS. 4-AB show an outer shell material being conveyed and printed, in accordance with one embodiment.

FIG. 5 illustrates a firefighter protective garment, in accordance with one embodiment.

FIG. 6 illustrates a firefighter protective coat of the firefighter protective garment of FIG. 5.

FIG. 7 illustrates firefighter protective pants of the firefighter protective garment of FIG. 5.

### DETAILED DESCRIPTION

In the following description, similar features in the drawings have been given similar reference numerals, and, to not unduly encumber the figures, some elements may not be indicated on some figures if they were already identified in one or more preceding figures. It should also be understood herein that the elements of the drawings are not necessarily depicted to scale, since emphasis is placed upon clearly illustrating the elements and structures of the present embodiments.

The terms “a”, “an” and “one” are defined herein to mean “at least one”, that is, these terms do not exclude a plural number of elements, unless stated otherwise. It should also be noted that terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

It will be appreciated that positional descriptors indicating the position or orientation of one element with respect to another element are used herein for ease and clarity of description and should, unless otherwise indicated, be taken in the context of the figures and should not be considered limiting. It will be understood that spatially relative terms (e.g., “outward” and “inward”, “frontward” and “rearward”, “front” and “rear”, “left” and “right”, “top” and “bottom” and “outer” and “inner”) are intended to encompass different positions and orientations in use or operation of the present embodiments, in addition to the positions and orientations exemplified in the figures.

Generally described, the present disclosure relates to a process for manufacturing firefighter protective garments and firefighter protective garments produced therefrom. The firefighter protective garment described herein includes an inner protective liner (referred to as the “inner liner”) and an outer protective shell (referred to as the “outer shell”). The inner liner includes one or more layers and is in contact with the body of the firefighter when worn. The inner liner typically includes a moisture barrier, which can be made, for example and without being limitative of expanded polytetrafluoroethylene (ePTFE) and/or polyurethane (PU) laminated to a woven or non-woven aramid substrate. The inner liner also typically includes a thermal barrier including a face cloth quilted to an aramid substrate. The outer shell is made of a flame-resistant or a flame-retardant material. Such a flame-resistant or a flame-resistant material can include but is not limited to a fabric of aramid fibers. A common fire-resistant material is sold under the trademark NOMEX. The outer shell typically has a sufficient mechanical resistance to provide the firefighter protective garment with resistance to abrasion and/or puncture. The inner liner is typically separable from the outer shell to facilitate inspection, maintenance, washing and care of the inner liner and the outer shell.

It is to be noted that, in the context the current disclosure, the firefighter protective garment can be embodied by a firefighter protective coat and/or firefighter protective pants. Accordingly, even if some passages of the present description explicitly refer to the firefighter protective coat or the firefighter protective pants, it would be readily understood that these passages could implicitly refer to both, except otherwise specified.

### Process for Manufacturing Firefighter Protective Garments

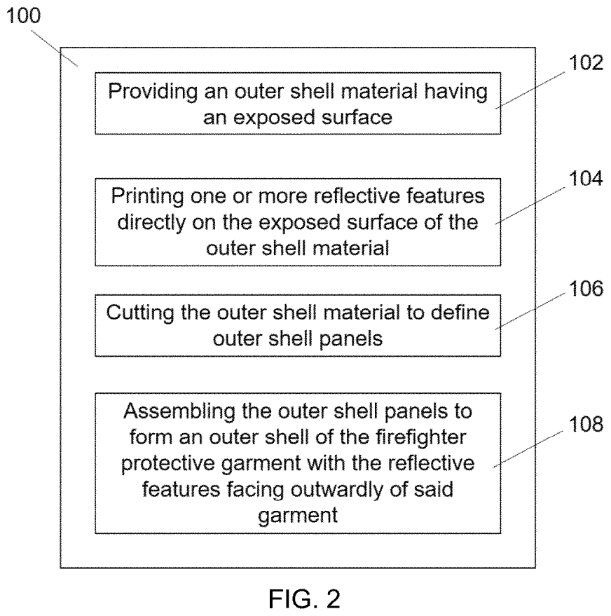

With reference to FIG. 2, a process 100 for manufacturing a firefighter protective garment will now be described.

The process 100 includes a step 102 of providing an outer shell material having an exposed surface. In some embodiments, the outer shell material may be provided on a web roller in the form of an unprinted web and may be unrolled or unwrapped. In these embodiments, the step 102 may thus include unrolling the unprinted material web from the web roller and conveying the unprinted material web. It is to be noted that the whole outer shell material may be provided or only portions thereof. In the latter case, a first portion of the outer shell material is provided and, at least one other portion of the outer shell is subsequently provided. The different portions of the outer shell material may be assembled altogether later during the manufacturing process to form the outer shell material, and eventually the outer shell, as will be explained below. The same applies for the other portion(s) of the firefighter protective garment, such as, for example and without being limitative, the inner liner and the layer(s) forming the same.

In some embodiments, the outer shell material may be flattened, for example and without being limitative by being provided on a flat surface or a table. The step of flattening the outer shell material may be carried out as the outer shell is pulled or conveyed.

The process 100 also includes a step 104 of printing one or more reflective features directly on the exposed surface of the outer shell material. The step 104 is generally carried out after the step 102. During the step 104, portion(s) of the outer shell material or the entire outer shell material may be sent towards a printing station, namely a station wherein reflective features may be provided on the outer shell material. In some embodiments, the printed reflective features define zones that are reflective or at least partially reflective, by contrast with other portions of the outer shell material that have not been printed.

The step 104 of printing the reflective features on the outer shell material is not limited to inkjet printing or a certain type of printing, but rather encompasses any additive manufacturing step(s) or method(s) according to which the reflective features may be provided on the outer shell, as long as it differs from affixing a band, for instance by seaming or gluing a band of material on the outer shell. One would have readily understood that flattening the outer shell material before the step 104 may facilitate the printing of the reflective features, as it is generally accepted that it is easier to print a material on a relatively flat surface. Of course, other technique may be used to flatten at least a portion of the outer shell material prior or during the step 104 of printing the reflective features.

The printed reflective features will now be described in greater detail. The printed reflective features are made from a printable material that is configured, i.e., designed to enhance the visibility of the firefighter in any light conditions, such as and without being limitative, normal light conditions, daylight condition, nighttime light conditions or in substantially low light conditions, after its application on the outer shell material and drying. In the context of the current description, the expression “reflective features” refers to features emitting, reflecting, producing and/or generating light situated in the region of the electromagnetic spectrum that is perceptible to human vision under given circumstances, such as the light conditions listed above. For instance, the printed reflective features are such that they can be seen by other while allowing to see the others during the normal activities of a firefighter.

During the firefighting activities, the printed reflective features may be seen by others because of the reflection of the ambient light by the reflective features. In the context of firefighting activities, “ambient light” includes, but is not limited to light generated by firefighter truck(s), flashlight(s), the fire and/or the like. The reflectivity of the printed reflective features may be a characteristic of interest. In the context of the current disclosure, the expression “reflectivity” encompasses any types of reflections, such as, for example diffuse reflection, specular reflection and retroreflection. Diffuse reflection occurs when incident light strikes the printed reflective features and scatters in all directions as diffusely reflected light. Specular reflection occurs when incident light strikes a lustrous and smooth surface, which may be, for example, the surface of the printed reflective features. The specularly reflected light is reflected off the surface of the surface at an equal but opposite angle to the source. The printed reflective features may have a combination of diffuse and specular reflective properties. Retro-reflection occurs when the surface of an object or a portion thereof, such as the printed reflective features reflects light back towards the source along a direction that is parallel to but opposite in direction from the incident source light. In other words, the retroreflected light is redirected back towards its source.

The step 104 of printing the reflective features may include applying a solution containing a reflective material on the exposed surface of the outer shell material. The application of the solution containing the reflective material may be embodied by different techniques, such as, for example, inkjet printing, screen printing, transfer printing, thermal transfer printing or any combinations thereof.

When screen printing or a similar technique is used, the step 104 of printing the reflective allows transferring the reflective material on the outer shell, except in predetermined areas. Such a transfer can be achieved, for example and without being limitative by blocking regions of the outer shell material with a stencil. The stencil can include, for example and without being limitative, full portions, as well as opened portions (e.g., hole and/or slot) for allowing the passage of the reflective material therethrough. It is to be noted that the stencil can be the positive or the negative image of the printed features. In this example, the reflective material is poured, i.e., printed, on the stencil. A movable blade or squeeze sweeps the surface of the stencil to fill the opened portions of the stencil, and the stencil is momentarily applied to, i.e., pressed against the outer shell material, thereby transferring the reflective material to the outer shell.

The reflective features may also be provided using a punch template similar to a stamp. In this embodiment, the stamp includes a pattern, word(s) or image(s) to be reproduced on the outer shell. A portion of the stamp is then covered with the reflective material and transferred to the outer shell by exerting a pressure on the stamp towards the outer shell material, thereby placing the reflective material in mechanical contact with the exposed surface of the outer shell.

In some embodiments, applying the solution includes mechanically contacting the outer shell material with a sponge filled with the solution. Upon application of pressure to the sponge, the solution may be transferred to the outer shell material in the regions where the sponge mechanically contacts the outer shell material. In some embodiments, applying the solution includes mechanically contacting the outer shell material with a roller covered with the solution. Upon application of a force on the roller towards the outer shell material, the solution may be transferred towards the outer shell material.

In some embodiments, applying the solution includes dispensing the solution from a printing head. In these embodiments, the step 104 of printing the reflective features may also include monitoring a position of the printing head relative to the outer shell material with a sensor. The position of the printing head relative to the outer shell material could be, for example, the last position where the reflective features were printed on the outer shell material. The step 104 may also include generating a displacement command with a controller, based on the monitored position of the printing head. The step 104 may also include displacing the printing head towards a subsequent position, based on the displacement command. The subsequent position could be, for example, the next position where the reflective features will be printed.

A treatment may be applied to the reflective features after their printing. In some embodiments, the process 100 includes thermally treating the solution after its application on the exposed surface of the outer shell. In other embodiments, the process 100 includes optically treating the solution after its application on the exposed surface of the outer shell.

In some embodiments, the process 100 further includes, prior to the application of said solution, providing an absorbent layer underneath the outer shell material configured to absorb an excess of said solution.

The step 104 of printing the reflective features may include projecting a particulate substance containing a reflective material on the exposed surface of the outer shell material. In some embodiments, the particulate substance includes a magnetic substance, and the process 100 further includes magnetically charging the outer shell material. A treatment may be applied to the reflective features after their printing. In some embodiments, the process 100 includes thermally treating the solution after its application on the exposed surface of the outer shell. In other embodiments, the process 100 includes optically treating the solution after its application on the exposed surface of the outer shell. In some embodiments, optically treating the particulate substance includes exposing the particulate substance to ultraviolet radiation.

The reflective material contained in the solution or the particulate substance may be selected based on desired functionalities, properties and/or esthetic purpose. The reflective material may be elected based on its ability to reflect light or light from a predetermined portion of the electromagnetic spectrum when illuminated by a light source or under specific lights conditions, for example and without being limitative, lights of emergency vehicles or other light sources generally present on an emergency scene. The reflective material may include pigment(s), dye(s), solvent(s), pigment(s), solubilizer(s), surfactant(s), lubricant(s), resin(s), particle(s) and/or the like. The ratio of each component one with respect to another has an impact on the resulting properties of the reflective material, and as such may affect the thickness, the appearance, the color, the viscosity and/or other relevant characteristics of the reflective material, and so the printed features. A variation of this ratio could provide the reflective material with specific properties that may be required to conform to a standard. In some embodiments, the reflective material can include color-enhancing agents and/or optical brightening agents to provide the printed features with a more visible or flashing appearance. In some embodiments, the reflective material could include at least one of the following: a photoreflective material, a fluorescent material (i.e., emission of light by the visible bands after the absorption of light or electromagnetic radiation), a photoluminescent material (i.e., light emission after the absorption of photons) or a phosphorescent material (i.e., materials having a “glow in the dark” appearance). Broadly described, such material(s) could be added to the reflective material such that when the printed features are formed, the printed features remain visible by other, notwithstanding the ambient light conditions in which the firefighting activities could take place. In some embodiments, the composition of the reflective material can be tailored to achieve a level of brightness and/or reflectivity, while maintaining heat resistance properties. Such heat resistance properties include maintaining the general shape and other physical and/or mechanical properties of the printed features when exposed to the firefighting activities conditions.

The reflective material generally includes one or more dyes. The dye could either be natural or synthetic, as long as it changes the visual aspect, namely the color, of the outer shell material when printed thereon. The dye can be incorporated in an aqueous solution, and generally has a chemical and/or physical affinity with the surface to which it is applied, i.e., the outermost surface of the outer shell. In some embodiments, the use of dye(s) can require the addition of further additive, such as, for example and without being limitative, a mordant to improve the physical and/or mechanical characteristics of the dye.

As it has been previously described, the reflective material may be contained in a solution (liquid phase) or in a particulate substance (solid phase). It is to be noted that the reflective material may be provided in a gas phase prior to its condensation on the outer shell material or in the form of a paste.

When the reflective material is dried on the outer shell, the printed reflective features can be flexible and light, just as the remaining portions of outer shell or the firefighter protective garment. It is to be noted that since there is no seam for affixing the reflective band(s) or other feature(s) to the firefighter protective garment, the use of a reflective material could participate, in some embodiments, to an even a greater flexibility of the firefighter protective garment. The presence seams or other affixing means could have otherwise constricted or limited certain movements of the firefighter.

During the step 104 of printing the reflective features, one or more features are printed on the outer shell of the firefighter protective garment. For example, and without being limitative, one or more reflective rectangular zones can be printed at least one of the waist portion(s), the leg portion(s), the ankle portion(s), the arm portion(s) and the wrist portion(s) of the firefighter protective garment. While the printed features generally includes rectangular zone (i.e., printed “band(s)”), they may also include other customization features, for example and without being limitative, the name of the firefighter, the city, the fire station or any other relevant information that can be useful in the context of firefighting activities.

It is to be noted that the firefighter protective garment, and more specifically the outer shell can undergo a surface treatment prior to the application of the printed reflective features, for example and without being limitative a treatment that would improve the adherence of the reflective material on the outer shell. This surface treatment could be performed as being a sub-step of the step 104 or could alternatively be performed upstream of the step 104

In some embodiments, the process 100 further includes heating the outer shell material, for example before or during the step 104 of printing the reflective features.

A step of physically marking the outer shell material prior to or during the step 104 of printing the reflective features may further be carried out. Indeed, the outer shell material can be marked, for example and without being limitative with reference symbols such as lines and/or points to determine zone(s) wherein the reflective material is applied during the step 104 of printing the reflective features.

More particularly, the process 100 may include providing position marks on the outer shell material for the reflective features prior to the step 104 of printing the reflective features. In some embodiments, providing the position marks may include printing the position marks. In some embodiments, the process 100 further includes detecting at least one of the position marks with a camera and beginning printing said the reflective features following detection of the position mark(s).

In some embodiments, the process 100 may further include tracing at least one pattern defining at least one zone to be covered with the reflective material, before printing the reflective features. In one non-limitative example, this step could include tracing two parallel lines on the outer shell material, hence defining a rectangular zone to be covered with the printed reflective material.

One would readily understand that the step of physically marking the outer shell material or tracing the pattern on the outer shell material may be performed to obtain a template of the zones(s) where the printed reflective material is to be applied, and so can guide or assist the step 104 of printing the reflective features.

The process 100 also includes a step 106 of cutting the outer shell material to define outer shell panels. The step 106 is generally achieved after the step 104 of printing the reflective features but could be, in some embodiments, carried out before the step 104. The step 106 of cutting the outer shell material may allow defining different outer shell panels to be assembled, in the embodiments wherein the step 106 is carried after the step 104. In the embodiments wherein the step 106 is completed before the step 104, the step 106 of cutting may allow defining different portions of the outer shall material. It will be noted that the step 106 may also be useful in the context of removing an excess of the outer shell material, either before or after the step 104 of printing the reflective features.

The step 106 of cutting the outer shell material may be performed on a cutting table or similar instruments already known in the art. The cut may be made by a cutter, a blade, a laser or any combinations thereof. It will be noted that the cutter, blade or laser may be provided at one extremity of a robotised arm. The robotised arm can either be manually operated or automated to enable automation of the step 106. In some embodiments, the printing station(s) may be mounted directly on the cutting table, either upstream or downstream of the cutter, blade or laser. In these embodiments, the steps 104 and 106 may be performed in a continuous or a near-continuous regime. Alternatively, the steps 104 and 106 may be simultaneous or concomitant, i.e., the outer shell may be cut as the reflective features are printed thereon or vice-versa.

The process 100 also includes a step 108 of assembling the outer shell panels to form an outer shell of the firefighter protective garment with the reflective features facing outwardly of the firefighter protective garment. In some embodiments, the step 108 of assembling the outer shell panels includes securing together at least two outer shell panels. The step 108 of assembling the outer shell panels may include folding outer shell panel(s) and assembling the folder outer shell panel(s) together to define the outer shell. The step 108 of assembling the outer shell panels together may be achieved by seaming, sewing, gluing, attaching and/or affixing the outer shell panels or portions thereof, so as to define an assembled outer shell having printed features thereon, the reflective features facing outwardly of the firefighter protective garment.

The other components of the firefighter protective garment, such as, for example and without being limitative, the inner liner, can be manufactured according to methods already known in the art. The process 100 for manufacturing the firefighter protective garment may then include a step of manufacturing the other components of the firefighter protective garment and a step of assembling the other components with the outer shell. Once this step is completed, the firefighter protective garment is ready to be worn and used in firefighting activities or similar events.

It is to be noted that one or more the preceding steps can be automatically executed or performed, for example and without being limitative by an industrial robot. In the context of the current disclosure, the expression “industrial robot” refers to a system that is programmed to be automated in the execution of a task. The task may include, but is not limited to cutting, marking, painting, printing, coating, treating, or any other similar applications that could be used in the context of manufacturing a firefighter protective garment. More specifically, the industrial robot can be particularly useful in the step 104 of printing the reflective features, on the outer shell and/or the step 106 of cutting the outer shell material, which may facilitate the integration of these steps in the whole manufacturing process, and thereby allowing manufacturing firefighter protective garments in a continuous or near-continuous regime. Manufacturing the firefighter protective garments in a continuous or near-continuous regime may help or contribute in increasing the overall efficiency of the manufacturing process of firefighter protective garments.

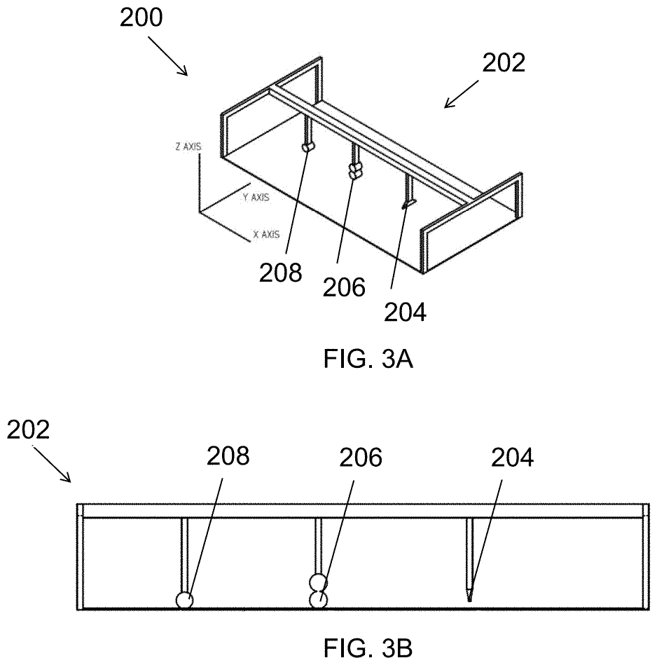

Now turning to FIGS. 3A-B and 4A-B, two embodiments of an apparatus 200 for manufacturing firefighter protective garments will now be described. The apparatus 200 may be useful implementing the process 100 which has been previously described.

In FIGS. 3A-B, there is shown an embodiment of an apparatus 200 including a printing station 202 for sequentially printing reflective features with different printing techniques. The printing station 202 includes a printing head 204 for applying the solution containing the reflective material or projecting the particulate substance containing the reflective material. The printing station 202 also includes a multiple-step roller 206 positioned downstream of the printing head 204. The solution containing the reflective material may flow on the surface of the multiple-step roller 206. The multiple-step roller may then mechanically contact the outer shell material, as described above. The printing station 202 also includes a single-step roller 208 that may be operated similarly to the double-step roller 206. It will be noted that each of the printing head 204, the double-step roller 206 and the one-step roller 208 may be configured to print reflective features having different properties on the outer shell material, e.g., one may be configured to print a retroreflective material, another one to print a fluorescent material and the remaining one to print a phosphorescent material. Alternatively, the printing head 204, the double-step roller 206 and the one-step roller 208 may be configured to print reflective features having the same properties, which may be useful to provide a thicker layer of reflective features. In some embodiments, each of the printing head 204, the double-step roller 206 and the one-step roller 208 may be configured to translate along one, two or three axes.

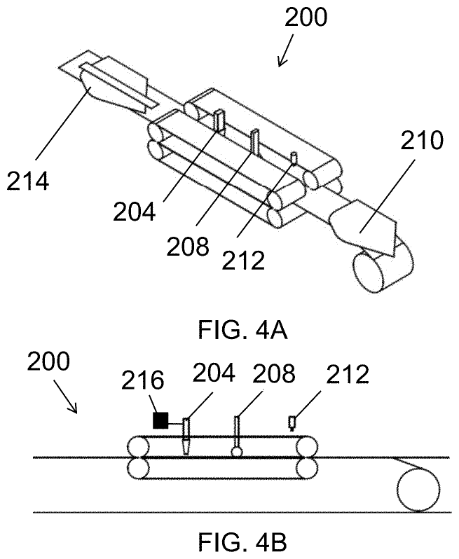

In FIGS. 4A-B, there is shown an embodiment of an outer shell material 210 being conveyed and printed. The outer shell material 210 may include position marks. The position marks may be detected with the camera 212 or similar detector. Upon detection of the position marks, the one-step roller 208 may be translated towards the outer shell material 210 to print the reflective features on the exposed surface of the outer shell material. Similarly, the printing head 204 may also be translated towards the outer shell material 210 to print the reflective features on the exposed surface of the outer shell material, resulting in a printed outer shell material 214. It is to be noted that at least one of the printing head 204 and the one-step roller 208 may be operatively connected to a controller 216. In the embodiment illustrated in FIG. 4B, the controller 216 is connected to the printing head 204. As it has been previously described, the position of the printing head may be monitored by a sensor and the controller 216 may be configured to generate a displacement command, based on the monitored position of the printing head 204.

### Firefighter Protective Garment

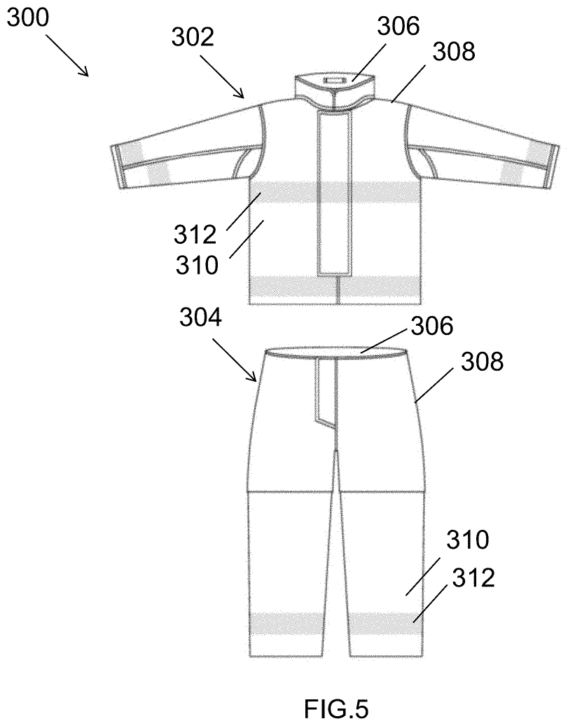

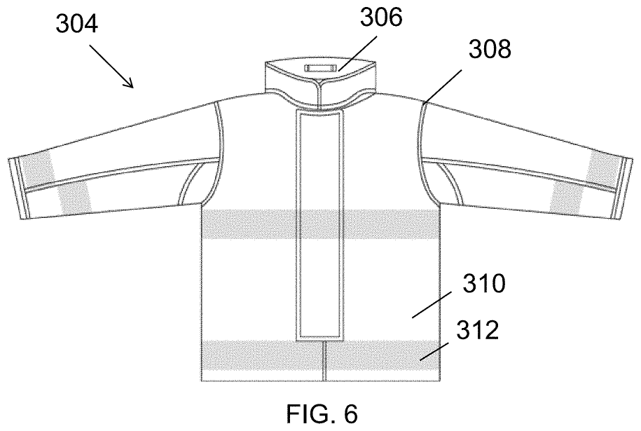

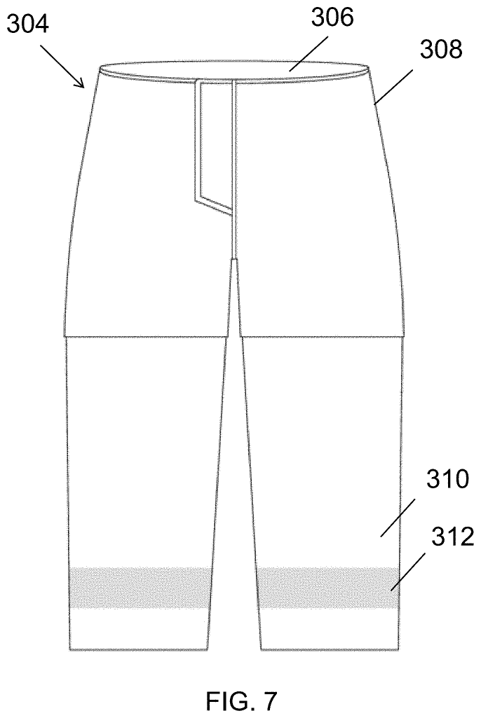

Now turning to FIG. 5, an embodiment of a firefighter protective garment 300 will be described. With reference to FIGS. 6 and 7 the firefighter protective garment 300 can embodied by a firefighter protective coat 302 or firefighter protective pants 304. It will be readily understood that the firefighter protective garment 300, the firefighter protective coat 302 and/or the firefighter protective pants 304 may be produced using the process 100 having been described above, or at least one of the steps of the process 100 which have been previously described.

With reference to FIGS. 5 to 7, the firefighter protective garment 300 includes an inner liner 306 and an outer shell 308. As it has been previously described, the outer shell 308 is made from a flame-resistant material and extends over at least a portion of the inner liner 306. The outer shell 308 has an outermost surface 310. The outermost surface 310 includes reflective features 312 printed directly on the outermost surface 310 of the outer shell 308. The reflective features 312 are sometimes referred to as “printed reflective features 312”. As illustrated in FIGS. 5 to 7, the reflective features 312 face outwardly of the firefighter protective garment 300.

As illustrated, the printed reflective features 312 may have the shape of rectangular band, but it will be understood that the printed reflective features 312 may have any other shapes and/or be provided in the form of pattern(s) provided on the outermost layer 310 of the outer shell 308, i.e., the layer of the firefighter protective garment 300 that remains visible from the outside of the firefighter protective garment when worn by the firefighter.

As it has been previously described, the printed reflective features 312 are provided on the outer shell 308 of the firefighter protective garment 300 with an additive process, namely by an addition of the reflective material on the outer shell 308. Examples of such an additive process have been previously presented, and include, while not being limited to printing, injection, inkjet printing, screen print, transfer printing, thermal transfer printing or the like. Of note, in the context of the present disclosure, the expression “additive process” does not include providing and affixing (e.g., seaming or gluing) the visible bands on the outer shell 308.

In some embodiments, the zones of the outermost surface 310 of the outer shell 308 having printed reflective features 312 have functionalities similar to the remaining portions of the outermost surface 310 of the outer shell 308. Such functionalities may include but are not limited to breathability of the outer shell 308, i.e., the outer shell 308 remains breathable remaining flame-resisting and/or flame-retarding, when the reflective features 312 are dried on the outermost surface 310 of the outer shell 308. In addition, the properties and/or functionalities of the printed features 312 may remain substantially the same over time, or at least not significantly change upon repeated expositions to the extreme conditions to which the firefighters are typically exposed.

Of course, one would readily have understood that the firefighter protective garments, and more particularly the firefighter protective coats and firefighter protective pants herein described generally comply with NFPA 1971.

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. The present examples and embodiments, therefore, are to be considered in all respects as illustrative and not restrictive. Accordingly, while specific embodiments have been illustrated and described, numerous modifications come to mind without significantly departing from the current description.

1. A process for manufacturing a firefighter protective garment, the process comprising:
providing an outer shell material having an exposed surface;
printing one or more reflective features directly on the exposed surface of the outer shell material;
cutting the outer shell material to define outer shell panels; and
assembling the outer shell panels to form an outer shell of the firefighter protective garment with the reflective features facing outwardly of said garment.

2. The process of claim 1, wherein providing the outer shell material comprises unrolling an unprinted material web from a web roller and conveying the unprinted material web.

3. The process of claim 1, wherein printing said one or more reflective features comprises applying a solution containing a reflective material on the exposed surface of the outer shell material.

4. The process of claim 3, wherein applying said solution is carried out using inkjet printing.

5. The process of claim 3, wherein applying said solution is carried out using screen printing.

6. The process of claim 3, wherein applying said solution is carried out using transfer printing.

7. The process of claim 3, wherein applying said solution is carried out using thermal transfer printing.

8. The process of claim 3, wherein applying said solution comprises mechanically contacting the outer shell material with a sponge filled with said solution.

9. The process of claim 3, wherein applying said solution comprises mechanically contacting the outer shell material with a roller covered with said solution.

10. The process of claim 3, wherein applying said solution comprises dispensing said solution from a printing head.

11. The process of claim 10, further comprising:
monitoring a position of the printing head relative to the outer shell material with a sensor;
generating a displacement command with a controller, based on the monitored position of the printing head; and
displacing the printing head towards a subsequent position, based on the displacement command.

12. The process of claim 3, further comprising thermally treating said solution after the application of said solution on the exposed surface of the outer shell.

13. The process of claim 3, further comprising optically treating said solution after the application of said solution on the exposed surface of the outer shell.

14. The process of claim 3, further comprising, prior to the application of said solution, providing an absorbent layer underneath the outer shell material configured to absorb an excess of said solution.

15. The process of claim 1, wherein printing said one or more reflective features comprises projecting a particulate substance containing a reflective material on the exposed surface of the outer shell material.

16. The process of claim 15, wherein the particulate substance comprises a magnetic substance, the process further comprising magnetically charging the outer shell material.

17. The process of claim 15, further comprising thermally treating said particulate substance after the projection of said particulate substance on the exposed surface of the outer shell.

18. The process of claim 15, further comprising optically treating said particulate substance after the projection of said particulate substance on the exposed surface of the outer shell.

19. The process of claim 18, wherein optically treating the particulate substance comprises exposing the particulate substance to ultraviolet radiation.

20. The process of claim 1, further comprising providing position marks on the outer shell material for said one or more reflective features prior to said printing.

21. The process of claim 20, wherein providing the position marks comprises printing the position marks.

22. The process of claim 20, further comprising detecting at least one of the position marks with a camera and beginning printing said one or more reflective features following detection of said at least one of the position marks.

23. The process of claim 1, further comprising tracing at least one pattern defining at least one zone to be covered with the reflective material, before printing said one or more reflective features.

24. The process of claim 1, further comprising heating the outer shell material.

25. The process of claim 1, wherein assembling the outer shell panels comprises securing together at least two outer shell panels.

26. A firefighter protective garment, comprising:
an inner liner; and
an outer shell made from a flame-resistant material, the outer shell extending over at least a portion of the inner liner, the outer shell having an outermost surface, the outermost surface comprising reflective features printed directly thereon, the reflective features facing outwardly of said firefighter protective garment.
